(19) United States
(12) Patent Application Publication
(10) Pub. No.: US 2025/0219757 A1
(43) Pub. Date: Jul. 3, 2025

(54) PERIMETER SECURITY SYSTEM

(71) Applicant: Rebecca Lynn Walker, Millgrove (CA)

(72) Inventor: Rebecca Lynn Walker, Millgrove (CA)

(21) Appl. No.: 18/398,549

(22) Filed: Dec. 28, 2023

(51) Int. Cl. H04K 3/00

(52) U.S. Cl. CPC H04K 3/80; H04K 3/42

(57) ABSTRACT

A security system that is configured to be deployed around a structure wherein the security system provides broadcast of a radio wave signal so as to inhibit flying or operational interference of drones within a perimeter defined by the present invention. The present invention includes a controller wherein the controller has the necessary electronics to receive, store, transmit and manipulate data. In one application of the present invention the controller has operably coupled thereto a wire member wherein the wire member is deployed to define a perimeter around a structure. The wire member has operably coupled thereto a multitude of transmitters. The transmitters are configured to provide a directional radio wave transmission in an upwards direction from the wire member. An alternate application of the present invention deploys the controller and at least one transmitter adjacent a window of a multi-story building emitting a directional signal outward from the building.

### FIELD OF THE INVENTION

The present invention relates generally to property security, more specifically but not by way of limitation, a security system that is configured to be deployed in at least two applications wherein the system of the present invention inhibits the operation of flying craft such as drones from entering the airspace defined by the perimeter member of the present invention.

### BACKGROUND

Drones have become quite popular in North America with millions of enthusiasts now flying drones for various purposes. Drones are utilized by hobbyists and professionals for various activities with the most popular being photography. Drones can be operated from several kilometers away which provides the drone operator an opportunity to explore and photograph areas that they may otherwise be unable to access. This has led to a significant increase in the popularity of drones. Drones operate on four frequency bands: 2.4 GHz, 5.8 GHz, 433 MHz and 915 MHz. Most of the more expensive commercial drones operate on 2.4 GHz and 5.8 GHz and use GPS L1, enabling the pilot to fly the fixed wing or quadcopter up to approximately 5 km away. Amateur drones tend to use 433 MHz or 915 MHz, which considerably extends their range.

While drones provide enjoyment for many, they have become a nuisance for much of the population. Drone operators will routinely fly into areas were the drones are either not allowed or are not desired. As the drones can be operated from may miles away, some drone operators will fly over private residences and invade the privacy of the homeowner. This additionally comprises the security of the home and homeowner as the drone can capture video data that provides the drone operator with information that the homeowner does not want to be made public.

Accordingly, there is a need for a security system that can be deployed around a single family home or multi-family dwelling wherein the security system utilizes a plurality of transmitters that interfere with the operational frequency of drones so as to inhibit flying into a defined perimeter or limit the operational functionality thereof.

### SUMMARY OF THE INVENTION

It is the object of the present invention to provide a security system that is configured to establish a perimeter inhibiting flying or operational limitations of drones wherein the present invention includes a controller.

Another object of the present invention is to provide a security system that is operable to inhibit drones from flying into a designated area wherein the controller is operably coupled to a perimeter member.

A further object of the present invention is to provide a security system that is configured to establish a perimeter inhibiting flying or operational limitations of drones wherein the perimeter member includes a wire member having a multitude of transmitters.

Yet a further object of the present invention is to provide a security system that is operable to inhibit drones from flying into a designated area wherein the controller is operated with a software application on a smart phone.

Still another object of the present invention is to provide a security system that is configured to establish a perimeter inhibiting flying or operational limitations of drones wherein the transmitters emit a frequency that interferes with the operational frequency of a drone.

An additional object of the present invention is to provide a security system that is operable to inhibit drones from flying into a designated area wherein the transmitters of the present invention employ directional radio frequency jamming technique.

Yet a further object of the present invention is to provide a security system that is configured to establish a perimeter inhibiting flying or operational limitations of drones wherein the present invention can be configured to be deployed in a high-rise multi-family dwelling.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of an exemplary deployment of the present invention; and

FIG. 2 is a side view of an exemplary deployment of the present invention in a multi-story building.

### DETAILED DESCRIPTION

Referring now to the drawings submitted herewith, wherein various elements depicted therein are not necessarily drawn to scale and wherein through the views and figures like elements are referenced with identical reference numerals, there is illustrated a security system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

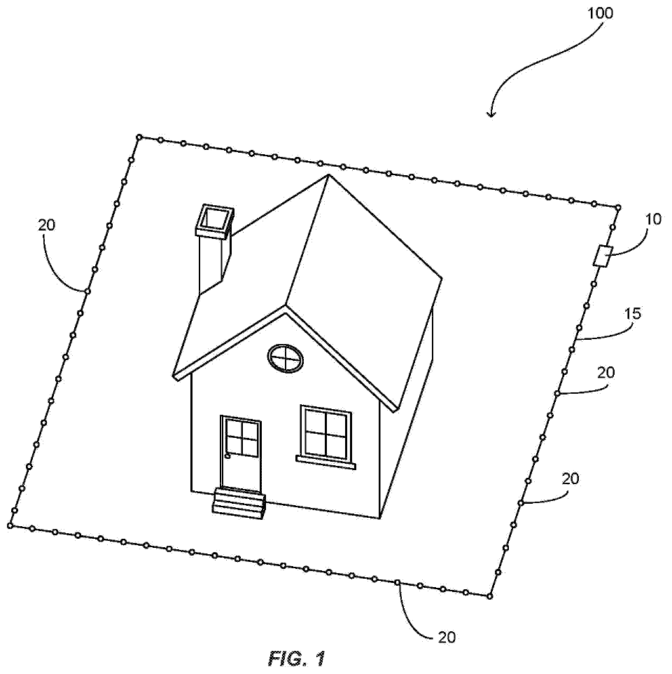

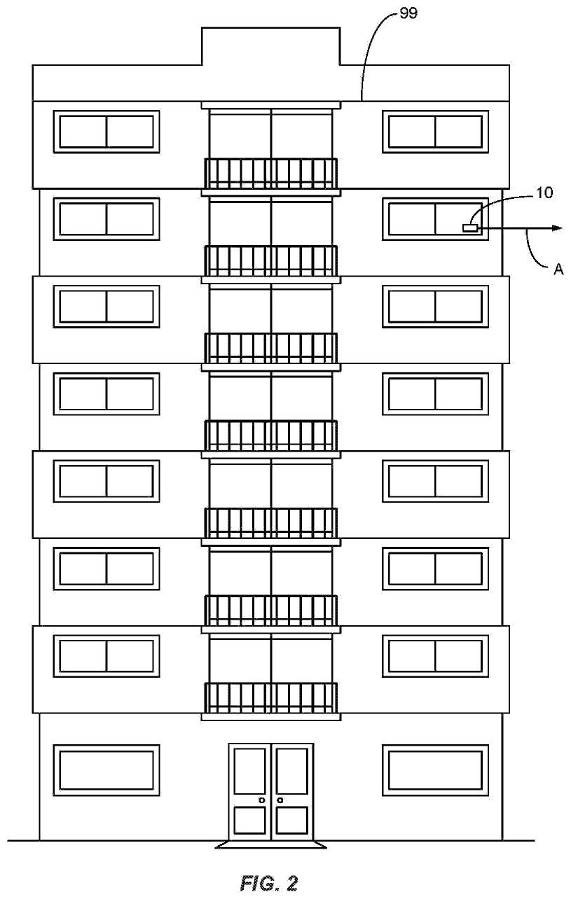

Referring in particular to the Figures submitted herewith, the security system 100 is configured to be deployed in at least two applications. One application is deployed around a perimeter of a single-family residence as is illustrated herein in FIG. 1. A second application of the present invention is illustrated herein in FIG. 2 wherein the security system 100 is installed in a multi-story building and is configured to inhibit upwards travel of a drone proximate to the building. The security system 100 includes a controller 10. The controller 10 is contained in a suitable housing and includes the necessary electronics to receive, store, transmit and manipulate data. The controller 10 can be configured to be buried, as is for the single-family residence application or be installed within a building, as is for the multi-story building application. The controller 10 is communicably coupled to a smart phone (not illustrated herein) wherein the smart phone includes a software application that provides a user interface for operation of the security system 100. It should be understood within the scope of the present invention that the software application provides the necessary functions via a graphical interface to provide operation of the functionality of the security system 100 as described herein.

The security system 100 includes a wire member 15. The wire member 15 is operably coupled to the controller 10 wherein the wire member 15 is configured to transmit data signals from the controller 10 to the transmitters 20. The wire member 15 is configured to be a direct burial wire for deployment around a perimeter of a single-family residence or similar structure. It should be understood within the scope of the present invention that the wire member could be provided in alternate lengths so as to be deployed around alternate sizes and shapes of perimeters around a structure. The wire member 15 has operably coupled thereto a plurality of transmitters 20. The transmitters 20 are operably coupled to the wire member 15 employing suitable techniques. The transmitters 20 are configured to emit radio waves that provide interference with the radio frequencies that are commonly employed to operate drones. The transmitters 20 in a preferred embodiment are configured to provide a directed emission of radio waves wherein the directional emission provides up to sixty degrees of broadcast from the transmitter and outward therefrom. In a single-family application as illustrated herein in FIG. 1, the transmitters 20 are buried underground around the perimeter area of the structure and are operable to broadcast radio waves in an upward direction wherein the broadcasted signal can have a beam width of up to sixty degrees. Depending upon the width of the broadcast radio wave from the transmitter 20, the quantity of the transmitters 20 operably coupled to the wire member 15 will vary. In a preferred embodiment of the single-family structure application, the transmitters 20 will be placed proximate each other so as to enable some degree of overlap of the broadcast signal from each transmitter 20. The overlap ensures a broadcast signal upwards from the wire member 15 deployed around the perimeter that will have no gaps inhibiting penetration of a drone into an airspace defined by the wire member 15. It should be understood within the scope of the present invention that the owner of the single-family residence can employ the transmitters 20 of the present invention to provide disablement of a drone, disablement of a drone camera or provide detection of the identification of the drone. Furthermore, the security system 100 is equipped with an audio alert that will provide an audio signal upon a drone entering the monitoring field of the security system 100.

Referring in particular to FIG. 2, an exemplary multi-story building application of the security system 100 is illustrated therein. The controller 10 is placed adjacent a window at a level which the owners of the multi-story building desire to inhibit flight of a drone thereabove. The controller 10 for this application includes an onboard transmitter configured to emit a directional radio wave indicated by arrow A. The directional radio wave is emitted outwards from the multi-story building being generally perpendicular thereto so as to inhibit travel of drones upward therepast. It should be understood within the scope of the present invention that transmitters 20 could be placed on the exterior of the building 99 on all sides thereof so as to project a radio signal outward from all sides of the building 99. It should be understood within the scope of the present invention that the security system 100 can be utilized by property management or an individual owner of a residence within a multi-story building to provide disablement of a drone camera or provide detection of the identification of the drone.

It should be understood within the scope of the present invention that the transmitters 20 of the present invention emit a radio wave operable to inhibit operation of drones employing the frequencies: 2.4 GHz, 5.8 GHz, 433 MHz and 915 MHz. Furthermore, while a directional radio wave emission is employed in the preferred embodiment of the present invention, it is contemplated within the scope of the present invention that the transmitters 20 could broadcast omnidirectional and/or targeted radio wave signals.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A security system that is configured to provide operational interference with a flying drone wherein the security system comprises:
a controller, said controller having electronics configured to receive, store, transmit and manipulate data;
a wire member, said wire member being operably coupled to said controller, said wire member configured to be buried in ground around a perimeter of a structure;
a multitude of transmitters, said multitude of transmitters operably coupled to said wire member, said multitude of transmitters configured to emit a radio wave signal, wherein the radio wave signal emitted from the multitude of transmitters provides operational interference with frequencies employed to operate drones.

2. The security system configured to provide operational interference with a flying drone as recited in claim 1, wherein the radio wave signal transmitted from the multitude of transmitters is a directional radio wave signal.

3. The security system configured to provide operational interference with a flying drone as recited in claim 2, wherein the radio wave signal transmitted from the multitude of transmitters has a beam width of up to sixty degrees.

4. The security system configured to provide operational interference with a flying drone as recited in claim 3, wherein the radio wave signal broadcast from the multitude of transmitters interfere with the following signal frequencies: 2.4 GHZ, 5.8 GHz, 433 MHz and 915 MHz.

5. The security system configured to provide operational interference with a flying drone as recited in claim 4, wherein the controller is operably coupled to a smart phone.

6. A security system that is configured to provide operational interference with a flying drone wherein the security system comprises:
a controller, said controller having electronics configured to receive, store, transmit and manipulate data, said controller being disposed adjacent a window in a multi-story building;
at least one transmitter, said at least one transmitter configured to emit a directional radio wave signal, wherein the radio wave signal emitted from the at least one transmitter provides operational interference with frequencies employed to operate drones.

7. The security system configured to provide operational interference with a flying drone as recited in claim 6, wherein the radio wave signal broadcast from the at least one transmitter interfere with the following signal frequencies: 2.4 GHz, 5.8 GHz, 433 MHz and 915 MHz.

8. The security system configured to provide operational interference with a flying drone as recited in claim 7, wherein the radio wave signal transmitted from the at least one transmitter has a beam width of up to sixty degrees.
